(19) United States
(12) Patent Application Publication
(10) Pub. No.: US 2010/0041837 A1
(43) Pub. Date: Feb. 18, 2010

(54) POLYARYLETHERS, BLENDS AND METHODS FOR MAKING

(76) Inventors: Gary William Yeager, Rexford, NY (US); Daniel Steiger, Bedminster, NJ (US); Yanshi Zhang, Shaker Heights, OH (US)

Correspondence Address: General Electric Company;GE Global Patent Operation, PO Box 861, 2 Corporate Drive, Suite 648, Shelton, CT, 06484, US

(21) Appl. No.: 12/191,211

(22) Filed: Aug. 13, 2008

(51) Int. Cl. C08G 75/23

(52) U.S. Cl. 525/534; 528/173

(57) ABSTRACT

A method for making a polyarylether having amide functionality includes reacting a dihydroxyaromatic compound having amide functionality with a dihaloaromatic sulfone or dinitroaromatic sulfone in the presence of a base. Polyarylethers having amide functionality and blends are also provided.

### FIELD OF THE INVENTION

The invention relates generally to functional polyarylethers, and more particularly, to polyarylethers having amide functionality.

### BACKGROUND OF THE INVENTION

Liquid filtration membranes for aqueous media must be porous, hydrophilic, have excellent mechanical properties to support the membrane during manufacture and use and must have adequate thermal properties to prevent the membrane from degrading during high temperature processes. Furthermore, these membranes must have nonspecific protein binding, such that membrane fouling is minimized. Membrane fouling is a major concern, resulting in reduced efficiency due to flux decline, high cleaning and maintenance costs and low membrane lifetimes.

Typical membrane materials are hydrophobic and require an additive to make the membrane more hydrophilic. Polysulfones have the mechanical and thermal properties necessary for liquid filtration membranes, but these polymers are insufficiently hydrophilic. To improve their hydrophilicity, polysulfones have been blended with hydrophilic polymers, such as polyvinylpyrollidone (PVP). However, PVP is water-soluble and is slowly leached from the porous polymer matrix creating product variability.

Thus, improved hydrophilic polymer materials that can be used to fabricate porous and hydrophilic membranes having good mechanical and thermal properties and improved fouling resistance and methods for making the hydrophilic polymer materials are desired.

### SUMMARY OF THE INVENTION

In one embodiment, a method for making a polyarylether having amide functionality comprises reacting a dihydroxyaromatic compound having amide functionality with a dihaloaromatic sulfone or a dinitroaromatic sulfone in the presence of a base.

In another embodiment, a polyarylether having amide functionality comprises units from at least one of structure I or structure II:

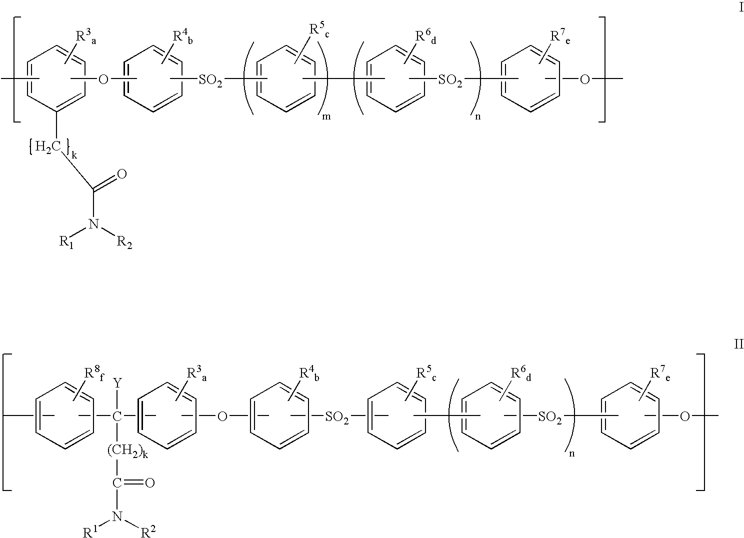

wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl;

R³, R⁴, R⁵, R⁶, R⁷ and R⁸ are each, independently, a nitro group, C₁-C₁₂ alkyl, C₃-C₃₀ aryl or a combination thereof;

Y is hydrogen, C₁-C₂₀ alkyl or C₃-C₃₀ aryl;

k is from about 0 to about 10;

a, b, c, d, e and f are each, independently, 0, 1, 2,3 or 4; and

m and n are each, independently, 0 or 1.

In another embodiment, a blend comprises a polyarylether having amide functionality and one or more resins, the polyarylether having amide functionality comprises units from at least one of structure I or structure II:

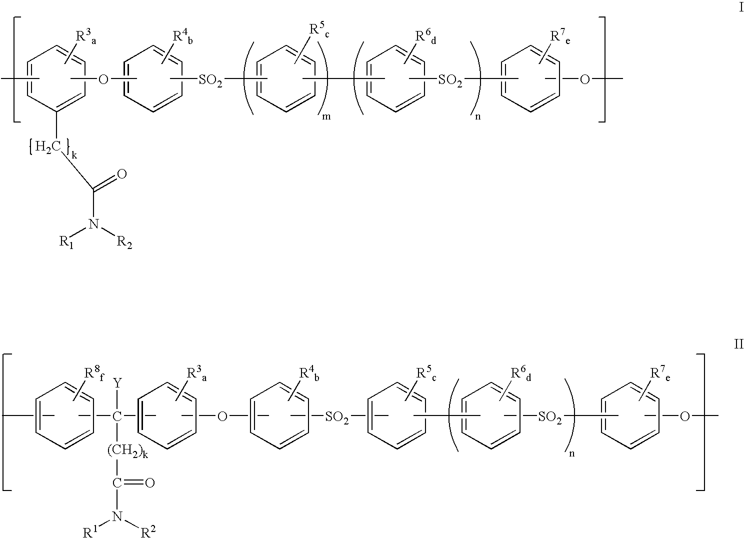

wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl;

R³, R⁴, R⁵, R⁶, R⁷ and R⁸ are each, independently, a nitro group, C₁-C₁₂ alkyl, C₃-C₃₀ aryl or a combination thereof;

Y is hydrogen, C₁-C₂₀ alkyl or C₃-C₃₀ aryl;

k is from about 0 to about 10;

a, b, c, d, e and f are each, independently, 0, 1, 2,3 or 4; and

m and n are each, independently, 0 or 1.

In another embodiment, a method for making a blend comprises mixing a polyarylether having amide functionality and one or more resins, wherein said polyarylether having amide functionality comprises units from at least one of structure I or structure II:

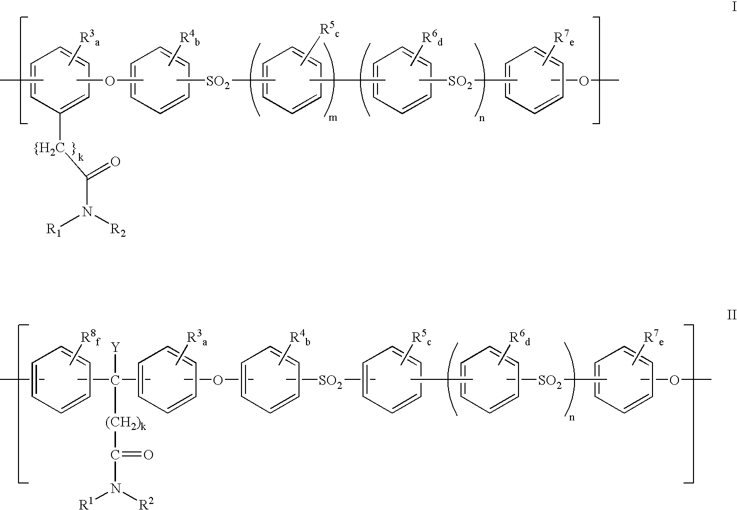

wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl;

R³, R⁴, R⁵, R⁶, R⁷ and R⁸ are each, independently, a nitro group, C₁-C₁₂ alkyl, C₃-C₃₀ aryl or a combination thereof;

Y is hydrogen, C₁-C₂₀ alkyl or C₃-C₃₀ aryl;

k is from about 0 to about 10;

a, b, c, d, e and f are each, independently, 0, 1, 2,3 or 4; and

m and n are each, independently, 0 or 1.

The various embodiments provide polyarylethers having amide functionality, methods for making the polyarylethers having amide functionality and blends that are hydrophilic and have good mechanical and thermal properties with improved fouling resistance.

### DETAILED DESCRIPTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, it is intended that values such as 15 to 85, 22 to 68, 43 to 51, 30 to 32, etc. are expressly enumerated in this specification. For values that are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

In one embodiment, a process for preparing a polyarylether having amide functionality is provided. The process includes reacting a dihydroxyaromatic compound having amide functionality with a dihaloaromatic sulfone or a dinitroaromatic sulfone in the presence of a base. A solvent and a phase transfer catalyst may optionally be used.

The dihydroxyaromatic compounds having amide functionality are dihydroxyaromatic compounds where at least one hydrogen is replaced by a functional group containing an amide group. Examples of dihydroxyaromatic compounds include, but are not limited to, bis(4-hydroxyphenyl)sulfide, bis(4-hydroxyphenyl)ether, bis(4-hydroxyphenyl)sulfone, bis(4-hydroxyphenyl)sulfoxide, 4,4′-(phenylphosphinyl)diphenol, 5-cyano-1,3-dihydroxybenzene, 4-cyano-1,3-dihydroxybenzene, 2-cyano-1,4-dihydroxybenzene, 2-methoxyhydroquinone, 2,2′-dimethylbiphenol, 2,2′,6,6′-tetramethylbiphenol, 2,2′,3,3′,6,6′-hexamethylbiphenol, 3,3′,5,5′-tetrabromo-2,2′,6,6′-tetramethylbiphenol, 2,2-bis(4-hydroxyphenyl)hexafluoropropane, 4,4′-(3,3,5-trimethylcyclohexylidene)diphenol, 1,1-bis(4-hydroxy-3-methylphenyl)cyclohexane, 4,4-bis(4-hydroxyphenyl)heptane, 2,4′-dihydroxydiphenylmethane, bis(2-hydroxyphenyl)methane, bis(4-hydroxyphenyl)methane, bis(4-hydroxy-5-nitrophenyl)methane, bis(4-hydroxy-2,6-dimethyl-3-methoxyphenyl)methane, 1,1-bis(4-hydroxyphenyl)ethane, 1,2-bis(4-hydroxyphenyl)ethane, 1,1-bis(4-hydroxy-2-chlorophenyl)ethane, 2,2-bis(3-phenyl-4-hydroxyphenyl)propane, 2,2-bis(4-hydroxy-3-methylphenyl)propane, 2,2-bis(4-hydroxy-3-ethylphenyl)propane, 2,2-bis(4-hydroxy-3-isopropylphenyl)propane, 2,2-bis(4-hydroxy-3,5-dimethylphenyl)propane, 3,5,3′,5′-tetrachloro-4,4′-dihydroxyphenyl)propane, bis(4-hydroxyphenyl)cyclohexylmethane, 2,2-bis(4-hydroxyphenyl)-1-phenylpropane, 2,4′-dihydroxyphenyl sulfone, 2,2-bis(4-hydroxyphenyl)butane, 2,2-bis(4-hydroxyphenyl)-2-methylbutane, 1,1-bis(4-hydroxyphenyl)cyclohexane, 2-(3-methyl-4-hydroxyphenyl-2-(4-hydroxyphenyl)propane, 2-(3,5-dimethyl-4-hydroxyphenyl)-2-(4-hydroxyphenyl)propane, 2-(3-methyl-4-hydroxyphenyl)-2-(3,5-dimethyl-4-hydroxyphenyl)propane, bis(3,5-dimethylphenyl-4-hydroxyphenyl)methane, 1,1-bis(3,5-dimethylphenyl-4-hydroxyphenyl)ethane, 2,2-bis(3,5-dimethylphenyl-4-hydroxyphenyl)propane, 2,4-bis(3,5-dimethylphenyl-4-hydroxyphenyl)-2-methylbutane, 3,3-bis(3,5-dimethylphenyl-4-hydroxyphenyl)pentane, 1,1-bis(3,5-dimethylphenyl-4-hydroxyphenyl)cyclopentane, 1,1-bis(3,5-dimethylphenyl-4-hydroxyphenyl)cyclohexane, bis(3,5-dimethyl-4-hydroxyphenyl)sulfoxide, bis(3,5-dimethyl-4-hydroxyphenyl)sulfone, bis(3,5-dimethylphenyl-4-hydroxyphenyl)sulfide, 2-carbamoylhydroquinone, 2,3-dicarbamoylhydroquinone, 2,2-bis(4-hydroxyphenyl)propane (bisphenol-A), resorcinol, catechol, hydroquinone, 2,6-dihydroxy naphthalene, 2,7-dihydroxynapthalene, 2,4′-dihydroxyphenyl sulfoxide, 2-diphenylphosphinylhydroquinone, bis(2,6-dimethylphenol) 2,2′-biphenol, 4,4′-biphenol, 4,4′-bis(3,5-dimethyl)biphenol, 4,4′-bis(2,3,5-trimethyl)biphenol, 4,4′-bis(2,3,5,6-tetramethyl)biphenol, 4,4′-bis(3-bromo-2,6-dimethyl)biphenol, 4,4′-isopropylidenebis(2,6-dibromophenol) (tetrabromobisphenol A), 4,4′-isopropylidenebis(2,6-dimethylphenol) (tetramethylbisphenol A), 4,4′-isopropylidenebis(2-methylphenol), 4,4′-isopropylidenebis(2-allylphenol), 4,4′-isopropylidenebis(2-allyl-6-methylphenol), 4,4′-isopropylidene-bis(2-phenylphenol), 4,4′(1,3-phenylenediisopropylidene)bisphenol (bisphenol M), 4,4′-(1,4-phenylenediisoproylidene)bisphenol (bisphenol P), 4,4′-sufonylbis(2,6-dimethylphenol), 4,4′-hexafluoroisoproylidene)bisphenol (Bisphenol AF), 4,4′-hexafluoroisopropylidene)bis(2,6-dimethylphenol), 4,4′(1-phenylethylidene)bisphenol (Bisphenol AP), 4,4′-(1-phenylethylidene)bis(2,6-dimethylphenol), 3,3-(4-hydroxyphenyl)pentane, bis(4-hydroxyphenyl)-2,2-dichloroethylene (Bisphenol C), bis(2,6-dimethyl-4-hydroxyphenyl)methane, 4,4′-(cyclopentylidene)diphenol, 4,4′-(cyclohexylidene)bis(2-methylphenol), 4,4′-bis(4-hydroxyphenyl)diphenyl ether, 9,9-bis(3-methyl-4-hydroxyphenyl)fluorene, N-phenyl-3,3-bis-(4-hydroxyphenyl)phthalimide, 4,4′-(cyclododecylidene)diphenol, 4,4′-(bicyclo[2.2.1]heptylidene)diphenol, 4,4′-(9H-fluorene-9,9-diyl)diphenol, 3,3-bis(4-hydroxyphenyl)isobenzofuran-1(3H)-one, 1-(4-hydroxyphenyl)-3,3-dimethyl-2,3-dihydro-1H-inden-5-ol, 1-(4-hydroxy-3,5-dimethylphenyl)-1,3,3,4,6-pentamethyl-2,3-dihydro-1H-inden-5-ol, 3,3,3′,3′-tetramethyl-2,2′,3,3′-tetrahydro-1,1′-spirobi[indene]-5,6′-diol (Spirobiindane), dihydroxybenzophenone (bisphenol K), tris(4-hydroxyphenyl)methane, tris(4-hydroxyphenyl)ethane, tris(4-hydroxyphenyl)propane, tris(4-hydroxyphenyl)butane, tris(3-methyl-4-hydroxyphenyl)methane, tris(3,5-dimethyl-4-hydroxyphenyl)methane, tetrakis(4-hydroxyphenyl)ethane, tetrakis(3,5-dimethyl-4-hydroxyphenyl)ethane, bis(4-hydroxyphenyl)phenylphosphine oxide, dicyclopentadienylbis(2,6-dimethyl phenol), dicyclopentadienyl bis(2-methylphenol) or dicyclopentadienyl bisphenol.

In one embodiment, the dihydroxyaromatic compounds having amide functionality have the structure IV or V:

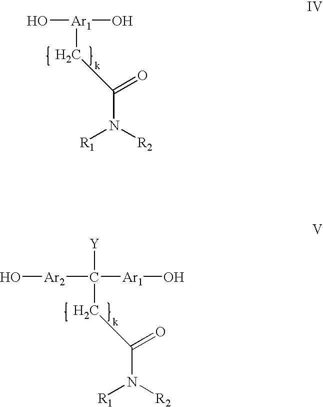

wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl;

k is from about 0 to about 10;

Y is hydrogen, C₁-C₂₀ alkyl or C₃-C₃₀ aryl;

Ar₁ and Ar₂ are each, independently, a C₃-C₃₀ aryl group, a C₃-C₃₀ aromatic-aliphatic group or a substituted C₃-C₃₀ aryl group.

In one embodiment, R₁ and/or R₂ may be methyl, ethyl, propyl, isopropyl, butyl, hexyl, heptyl, octyl, 4-methylpent-1-yl, phenyl, naphthyl or biphenyl. In another embodiment, R₁ and R₂ are covalently connected to form a cyclic moiety. In one embodiment, R₁ and R₂ form a cycloalkyl group. In another embodiment, R₁ and R₂ form a cyclohexyl group.

In another embodiment, R₁ and/or R₂ may be a substituted C₃-C₃₀ aryl group. In one embodiment, R₁ and/or R₂ are a C₃-C₃₀ aryl, such as phenyl, naphthyl or biphenyl, substituted with one or more members selected from the group consisting of C₁-C₂₀ alkyl, C₃₋C₃₀ aryl, halogen, nitrile, amide, hydroxyl, aryloxy, alkoxy, thioalkoxy, thioaryloxy, carbonyl, sulfonyl, carboxylate, carboxylic ester, sulfone, phosphonate, sulfoxide, carbamate, amine, phosphinyl, nitro, acylhydrazide, hydrazide, imide, imine, amidate, amidine, oxime, peroxide, diazo, azide, ether, ester, lactam, lactone, urea, urethane, phosphonamide, sulfonamide, alcohol, aldehyde and ketone. In one embodiment, halogen may include fluorine, chlorine, bromine or iodine.

In one embodiment, k is from about 0 to about 5. In another embodiment, k is from about 1 to about 3.

In one embodiment, Y may be methyl, ethyl, propyl, isopropyl, butyl, hexyl, heptyl, octyl, 4-methylpent-1-yl, phenyl, naphthyl or biphenyl.

In one embodiment, Ar₁ and/or Ar₂ may be phenyl, naphthyl or biphenyl. In another embodiment, Ar₁ and/or Ar₂ may be a substituted C₃-C₃₀ aryl group. In another embodiment, Ar₁ and/or Ar₂ is a C₃-C₃₀ aryl group, such as phenyl, naphthyl or biphenyl, substituted with one or more members selected from the group consisting of C₁-C₁₂ alkyl, C₃-C₃₀ aryl, a nitro group and combinations thereof.

In one embodiment, the dihydroxyaromatic compound having amide functionality is diphenolic morpholinamide or 2,2-bis(4-hydroxyphenyl)-1-propaneamide.

The dihydroxyaromatic compounds having amide functionality may be prepared by any conventional manner, such as described in U.S. Pat. No. 3,251,806, which is incorporated herein by reference. In one embodiment, the dihydroxyaromatic compound is prepared by heating an ammonium salt of a parent diphenolic acid compound with a secondary amine.

In one embodiment, the dihaloaromatic sulfone or dinitroaromatic sulfone has formula VI:

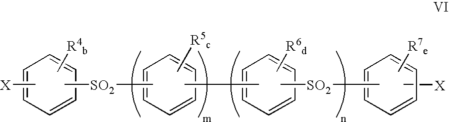

wherein X is a halogen or nitro group;

R⁴, R⁵, R⁶ and R⁷ are each, independently, a nitro group, C₁-C₁₂ alkyl, C₃-C₃₀ aryl or a combination thereof;

m and n are each, independently, 0 or 1; and

b, c, d and e are each, independently, 0, 1, 2,3 or 4.

In one embodiment, X is a halogen. In another embodiment, X may be chlorine, bromine or fluorine.

In one embodiment, R⁴, R⁵, R⁶ and/or R⁷ is methyl, ethyl, propyl, isopropyl, butyl, hexyl, heptyl, octyl, 4-methylpent-1-yl, phenyl, naphthyl or biphenyl.

In another embodiment, b, c, d and/or e are 0. In another embodiment, b, c, d and e are 0.

Examples of the dihaloaromatic sulfone include, but are not limited to, bis(4-chlorophenyl)sulfone, bis(4-fluorophenyl)sulfone, 4,4′-bis[(4-chlorophenyl)sulfonyl]-1,1′-biphenyl or 4,4′-bis[(4-fluorophenyl)sulfonyl]-1,1′-biphenyl. Functionalized polysulfones are readily available commercially.

The dihydroxyaromatic compound having amide functionality and the dihaloaromatic sulfone or dinitroaromatic sulfone are reacted in the presence of a base, which converts the dihydroxyaromatic compound to its corresponding alkali metal salt. In one embodiment, the base is a basic salt of an alkali metal compound. Examples of basic salts include, but are not limited to, alkali metal hydroxides, such as, lithium hydroxide, sodium hydroxide, potassium hydroxide, rubidium hydroxide and cesium hydroxide; alkali metal carbonates, such as, lithium carbonate, sodium carbonate, potassium carbonate, rubidium carbonate, and cesium carbonate; and alkali metal hydrogen carbonates, such as, lithium hydrogen carbonate, sodium hydrogen carbonate, potassium hydrogen carbonate, rubidium hydrogen carbonate and cesium hydrogen carbonate. Combinations of these compounds may also be used to effect the reaction.

In one embodiment, the base is present in an effective amount to deprotonate the hydroxyl groups of the dihydroxy aromatic compounds. In another embodiment, the base is present in at least an equimolar amount relative to the molar equivalents of hydroxyl functionality. In another embodiment, the base is present in an excess amount relative to the molar equivalents of hydroxyl functionality.

A solvent may be used in the reaction. The solvent may be a polar aprotic solvent or a chlorinated solvent. Some examples of an aprotic polar solvent include, but are not limited to, N,N-dimethylformamide, N,N-diethylformamide, N,N-dimethylacetamide, N,N-diethylacetamide, N,N-dipropylacetamide, N,N-dimethylbenzamide, N-methyl-2-pyrrolidone (NMP), N-ethyl-2-pyrrolidone, N-isopropyl-2-pyrrolidone, N-isobutyl-2-pyrrolidone, N-n-propyl-2-pyrrolidone, N-n-butyl-2-pyrrolidone, N-cyclohexyl-2-pyrrolidone, N-methyl-3-methyl-2-pyrrolidone, N-ethyl-3-methyl-pyrrolidone, N-methyl-3,4,5-trimethyl-2-pyrrolidone, N-methyl-2-piperidone, N-ethyl-2-piperidone, N-isopropyl-2-piperidone, N-methyl-6-methyl-2-piperidone, N-methyl-3-ethylpiperidone, dimethylsulfoxide (DMSO), diethylsulfoxide, sulfolane, 1-methyl-1-oxosulfolane, 1-ethyl-1-oxosulfolane, 1-phenyl-1-oxosulfolane, N,N′-dimethylimidazolidinone (DMI), diphenylsulfone, and combinations thereof. The amount of solvent to be used is typically an amount that is sufficient to dissolve the dihaloaromatic sulfone or dinitroaromatic sulfone and dihydroxy aromatic compounds.

Optionally, phase transfer catalysts may be employed to increase the rate of reaction and reaction yield. Phase transfer catalysts comprise an anionic species, such as a halide, mesylate, tosylate, tetrafluoroborate or acetate as the charge-balancing counterion(s). Examples of phase transfer catalysts include, but are not limited to, guanidinium salts, aminopyridinium salts, bis-quaternary ammonium salts, bis-quaternary phosphonium salts or phosphazenium salts. Examples of guanidinium salts include, but are not limited to, hexaalkylguanidinium salts or bis-guanidinium salts, such as those disclosed in U.S. Pat. Nos. 5,132,423; 5,116,975 and 5,081,298, which are incorporated herein by reference. In one embodiment, guanidinium salts include, but are not limited to, hexaethylguanidinium chloride, hexaethylguanidinium bromide, hexa-n-butylguanidinium bromide, 1,6-bis(N,N′,N′,N″,N″-penta-n-butylguanidinium)hexane dibromide, 1,6-bis(N-n-butyl-N′,N′,N″,N″-tetraethylguanidinium)hexane dibromide, tris(pentamethylene)guandinium bromide or 1,6-bishexalene(penta-n-butylguanidinium)dibromide. Examples of bis-quaternary ammonium and bis-quaternary phosphonium salts include, but are not limited to, those disclosed in U.S. Pat. No. 4,554,357, which is incorporated herein by reference, such as bis(tri-n-butyl)-1,4-butylenediammonium dibromide, bis(tri-n-butyl)-1,10-decylenediammonium dibromide, bis(tris-n-hexyl)-1,10-decylenediammonium dibromide, bis(tri-n-butyl)-1,6-hexylenediammonium dibromide, N,N′-di-n-butyl-1,4-diazabicyclo[2.2.2]octane dibromide or bis(tri-n-butyl)-1,6-hexylenephosphonium dibromide. In one embodiment, aminopyridinium salts include, but are not limited to, p-dialkylamino-pyridinium salts or bis-dialkylaminopyridinium salts, such as those disclosed in U.S. Pat. Nos. 4,460,778; 4,513,141 and 4,681,949, which are incorporated herein by reference. In one embodiment, aminopyridinium salts include, but are not limited to, N-2-ethylhexyldimethylaminopyridine chloride, N-2-ethylhexyl-4-methyl-piperidinylaminopyridine chloride, neopentyldibutylaminopyridinium bromide, N-neopentyl-4-N′-N′-dibutylaminopyridinium bromide, N-neopentyl-4-N′-N′-dihexylaminopyridinium bromide, tetraethylene glycol-bis(4-dimethylaminopyridinium)bismethanesulfonate, 1,8-bis(4-dimethylaminopyridinium)octane dibromide, 1,10-bis(4-dimethylaminopyridinium)decane dibromide, 1,6-bis(4-di-n-hexylaminopyridinium)hexane dibromide, bisaminopyridinium dibromide or 1,10-bis[4-(4-methyl-1-piperdinylpyridinium)decane]dibromide.

The phase transfer catalyst may be used in any amount effective for increasing the rate of reaction or increasing the yield of the reaction. In one embodiment, the phase transfer catalyst is added in an amount of from about 0.5 mole percent to about 5.0 mole percent based on the molar amount of the dihydroxyaromatic compound. In another embodiment, the phase transfer catalyst is added in an amount of from about 0.25 mole percent to about 2.5 mole percent based on the molar amount of the dihydroxyaromatic compound.

In one embodiment, the reaction is conducted at a temperature ranging from about 100° C. to about 300° C. In another embodiment, the temperature is in a range from about 120° C. to about 200° C. In another embodiment, the reaction temperature is in a range from about 150° C. to about 200° C.

The reaction is conducted for a time sufficient to react the dihydroxy compound and the dihaloaromatic sulfone or dinitroaromatic sulfone. In one embodiment, the reaction is conducted for a time period ranging from about 1 hour to about 72 hours. In another embodiment, the time period ranges from about 1 hour to about 10 hours. The reaction may be carried out under ordinary pressure or pressurized conditions.

The reaction mixture may be dried by adding an additional solvent to the initial reaction mixture. The additional solvent forms an azeotrope with water. Examples of such solvents include, but are not limited to, toluene, benzene, xylene, ethylbenzene or chlorobenzene. After removal of any residual water by azeotropic drying, the reaction is carried out at the reaction temperatures described above.

After completing the reaction, the polyarylether having amide functionality may be separated from the inorganic salts in the reaction mixture by precipitation into a non-solvent and collected by filtration and drying. The drying may be carried out either under vacuum and/or at high temperature, as is known commonly in the art. Examples of non-solvents include, but are not limited to, water, methanol, ethanol, propanol, butanol, acetone, methyl ethyl ketone, methyl isobutyl ketone, gamma-butyrolactone or combinations thereof. In one embodiment, water or methanol are used as the non-solvents.

The dihaloaromatic sulfone or dinitroaromatic sulfone may be used in substantially equimolar amounts relative to the dihydroxy aromatic compound having amide functionality used in the reaction mixture. The term “substantially equimolar amounts” means a molar ratio of the dihaloaromatic sulfone or dinitroaromatic sulfone to the dihydroxy aromatic compound having amide functionality is from about 0.85 to about 1.2. In another embodiment, the ratio is from about 0.9 to about 1.1 and from about 0.98 to about 1.02.

Some exemplary embodiments of the process include:

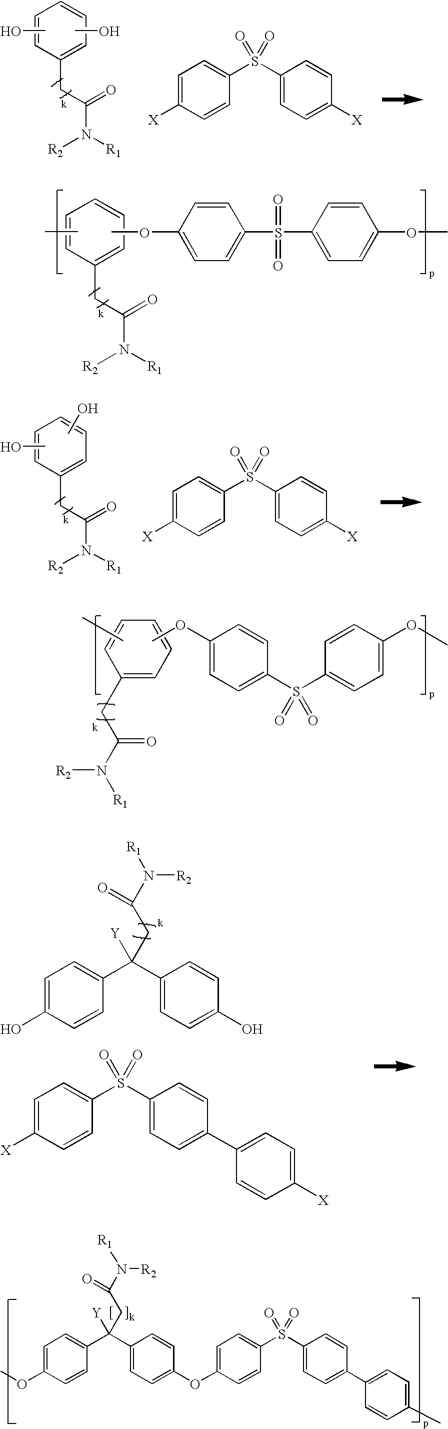

wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl;

Y is hydrogen, C₁-C₂₀ alkyl or C₃-C₃₀ aryl;

X is a halogen or nitro group;

p is from about 10 to about 10,000; and

k is from about 0 to about 10. In one embodiment, R₁ and/or R₂ may be methyl, ethyl, propyl, isopropyl, butyl, hexyl, heptyl, octyl, 4-methylpent-1-yl, phenyl, naphthyl or biphenyl. In another embodiment, R₁ and R₂ are covalently connected to form a cyclic moiety. In one embodiment, R₁ and R₂ form a cycloalkyl group. In another embodiment, R₁ and R₂ form a cyclohexyl group.

In another embodiment, R₁ and/or R₂ may be a substituted C₃-C₃₀ aryl group. In one embodiment, R₁ and/or R₂ are a C₃-C₃₀ aryl, such as phenyl, naphthyl or biphenyl, substituted with one or more members selected from the group consisting of C₁-C₂₀ alkyl, C₃-C₃₀ aryl, halogen, nitrile, amide, hydroxyl, aryloxy, alkoxy, thioalkoxy, thioaryloxy, carbonyl, sulfonyl, carboxylate, carboxylic ester, sulfone, phosphonate, sulfoxide, carbamate, amine, phosphinyl, nitro, acylhydrazide, hydrazide, imide, imine, amidate, amidine, oxime, peroxide, diazo, azide, ether, ester, lactam, lactone, urea, urethane, phosphonamide, sulfonamide, alcohol, aldehyde and ketone. In one embodiment, halogen may include fluorine, chlorine, bromine or iodine.

In one embodiment, k is from about 0 to about 5. In another embodiment, k is from about 1 to about 3.

In one embodiment, X is a halogen. In another embodiment, X may be chlorine, bromine or fluorine.

In one embodiment, Y may be methyl, ethyl, propyl, isopropyl, butyl, hexyl, heptyl, octyl, 4-methylpent-1-yl, phenyl, naphthyl or biphenyl.

In one embodiment, p is from about 10 to about 1000. In another embodiment, p is from about 100 to about 500.

In one embodiment, a polyarylether having amide functionality comprises units from at least one of structure I or structure II:

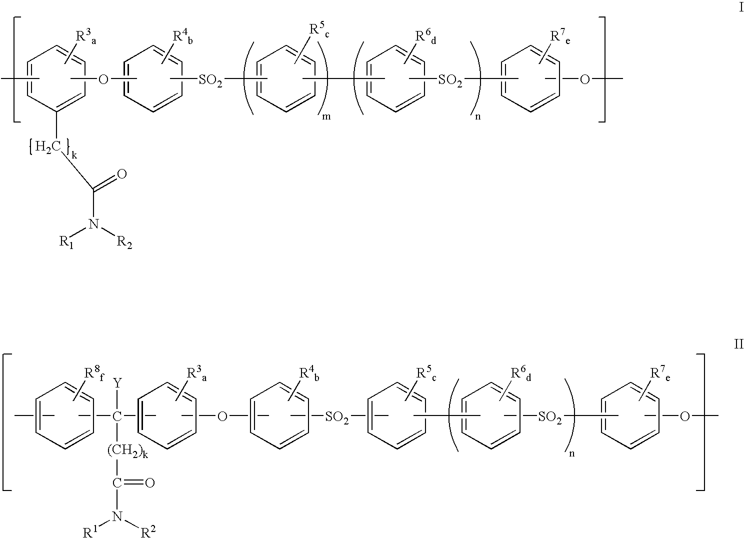

wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl;

R³, R⁴, R⁵, R⁶, R⁷ and R⁸ are each, independently, a nitro group, C₁-C₁₂ alkyl, C₃-C₃₀ aryl or a combination thereof;

Y is hydrogen, C₁-C₂₀ alkyl or C₃-C₃₀ aryl;

k is from about 0 to about 10;

a, b, c, d, e and f are each, independently, 0, 1, 2, 3 or 4; and

m and n are each, independently, 0 or 1.

In one embodiment, R₁ and/or R₂ may be methyl, ethyl, propyl, isopropyl, butyl, hexyl, heptyl, octyl, 4-methylpent-1-yl, phenyl, naphthyl or biphenyl. In another embodiment, R₁ and R₂ are covalently connected to form a cyclic moiety. In one embodiment, R₁ and R₂ form a cycloalkyl group. In another embodiment, R₁ and R₂ form a cyclohexyl group.

In another embodiment, R₁ and/or R₂ may be a substituted C₃-C₃₀ aryl group. In one embodiment, R₁ and/or R₂ are a C₃-C₃₀ aryl, such as phenyl, naphthyl or biphenyl, substituted with one or more members selected from the group consisting of C₁-C₂₀ alkyl, C₃-C₃₀ aryl, halogen, nitrile, amide, hydroxyl, aryloxy, alkoxy, thioalkoxy, thioaryloxy, carbonyl, sulfonyl, carboxylate, carboxylic ester, sulfone, phosphonate, sulfoxide, carbamate, amine, phosphinyl, nitro, acylhydrazide, hydrazide, imide, imine, amidate, amidine, oxime, peroxide, diazo, azide, ether, ester, lactam, lactone, urea, urethane, phosphonamide, sulfonamide, alcohol, aldehyde and ketone. In one embodiment, halogen may include fluorine, chlorine, bromine or iodine.

In one embodiment, k is from about 0 to about 5. In another embodiment, k is from about 1 to about 3.

In one embodiment, Y may be methyl, ethyl, propyl, isopropyl, butyl, hexyl, heptyl, octyl, 4-methylpent-1-yl, phenyl, naphthyl or biphenyl.

In one embodiment, a, b, c, d, e and/or f are 0. In another embodiment, a, b, c, d, e and f are 0.

In one embodiment, R³, R⁴, R⁵, R⁶ and/or R⁷ may be methyl, ethyl, propyl, isopropyl, butyl, hexyl, heptyl, octyl, 4-methylpent-1-yl, phenyl, naphthyl or biphenyl.

In one embodiment, the polyarylether having amide functionality comprises units of structure VII:

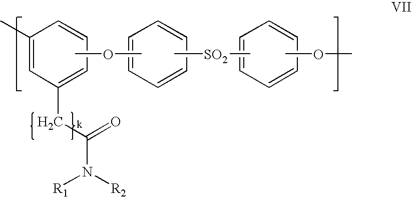

wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl; and

k is from about 0 to about 10.

In one embodiment, R₁ and/or R₂ may be methyl, ethyl, propyl, isopropyl, butyl, hexyl, heptyl, octyl, 4-methylpent-1-yl, phenyl, naphthyl or biphenyl. In another embodiment, R₁ and R₂ are covalently connected to form a cyclic moiety. In one embodiment, R₁ and R₂ form a cycloalkyl group. In another embodiment, R₁ and R₂ form a cyclohexyl group.

In another embodiment, R₁ and/or R₂ may be a substituted C₃-C₃₀ aryl group. In one embodiment, R₁ and/or R₂ are a C₃-C₃₀ aryl, such as phenyl, naphthyl or biphenyl, substituted with one or more members selected from the group consisting of C₁-C₂₀ alkyl, C₃-C₃₀ aryl, halogen, nitrile, amide, hydroxyl, aryloxy, alkoxy, thioalkoxy, thioaryloxy, carbonyl, sulfonyl, carboxylate, carboxylic ester, sulfone, phosphonate, sulfoxide, carbamate, amine, phosphinyl, nitro, acylhydrazide, hydrazide, imide, imine, amidate, amidine, oxime, peroxide, diazo, azide, ether, ester, lactam, lactone, urea, urethane, phosphonamide, sulfonamide, alcohol, aldehyde and ketone. In one embodiment, halogen may include fluorine, chlorine, bromine or iodine.

In one embodiment, k is from about 0 to about 5. In another embodiment, k is from about 1 to about 3. The polyarylethers having amide functionality are hydrophilic, but are not water soluble. They are solvent resistant polymers with a high glass transition temperature. In one embodiment, the glass transition temperature, T_{g}, of the polymer ranges from about 120° C. to about 280° C. In another embodiment, the polymer ranges from about 140° C. to about 250° C. In another embodiment, the T_{g} ranges from about 140° to about 225° C., including from about 175° C. to about 225° C.

The polyarylether having amide functionality may be characterized by number average molecular weight (Mₙ) and weight average molecular weight (M_{w}). The various average molecular weights Mₙ and M_{w} are determined by techniques, such as gel permeation chromatography, and are known to those skilled in the art. In one embodiment, the Mₙ of the polymer is in the range from about 10,000 g/mol to about 1,000,000 g/mol. In another embodiment, the Mₙ ranges from about 15,000 g/mol to about 200,000 g/mol. In another embodiment, the Mₙ ranges from about 20,000 g/mol to about 100,000 g/mol. In another embodiment, the Mₙ ranges from about 40,000 g/mol to about 80,000 g/mol. In one embodiment, the M_{w} of the polymer is in the range from about 10,000 g/mol to about 5,000,000 g/mol. In another embodiment, the M_{w} ranges from about 15,000 g/mol to about 1,000,000 g/mol. In another embodiment, the M_{w} ranges from about 20,000 g/mol to about 500,000 g/mol. In another embodiment, the Mₙ ranges from about 40,000 g/mol to about 400,000 g/mol.

In one embodiment, the polyarylether having amide functionality may be a homopolymer or a copolymer. In one embodiment, the polyarylether having amide functionality is a homopolymer comprising units from structure I. In another embodiment, the polyarylether having amide functionality is a homopolymer comprising units from structure II.

In another embodiment, the polyarylether having amide functionality is a copolymer. The copolymer may be random, block or graft. In one embodiment, the copolymer may be branched or hyperbranched. In one embodiment, a polyarylether copolymer having amide functionality comprises (A) units from at least one of structure I or structure II:

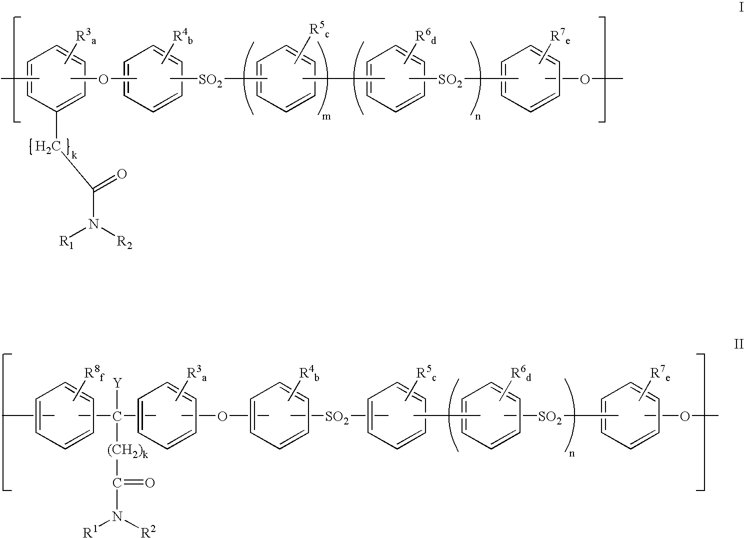

wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl;

R³, R⁴, R⁵, R⁶, R⁷ and R⁸ are each, independently, a nitro group, C₁-C₁₂ alkyl, C₃-C₃₀ aryl or a combination thereof;

k is from about 0 to about 10;

Y is hydrogen, C₁-C₂₀ alkyl or C₃-C₃₀ aryl;

a, b, c, d, e and f are each, independently, 0, 1, 2, 3 or 4;

m and n are each, independently, 0 or 1; and

(B) units from an aromatic ether.

In one embodiment, R₁ and/or R₂ may be methyl, ethyl, propyl, isopropyl, butyl, hexyl, heptyl, octyl, 4-methylpent-1-yl, phenyl, naphthyl or biphenyl. In another embodiment, R₁ and R₂ are covalently connected to form a cyclic moiety. In one embodiment, R₁ and R₂ form a cycloalkyl group. In another embodiment, R₁ and R₂ form a cyclohexyl group.

In another embodiment, R₁ and/or R₂ may be a substituted C₃-C₃₀ aryl group. In one embodiment, R₁ and/or R₂ are a C₃-C₃₀ aryl, such as phenyl, naphthyl or biphenyl substituted with one or more members selected from the group consisting of C₁-C₂₀ alkyl, C₃-C₃₀ aryl, halogen, nitrile, amide, hydroxyl, aryloxy, alkoxy, thioalkoxy, thioaryloxy, carbonyl, sulfonyl, carboxylate, carboxylic ester, sulfone, phosphonate, sulfoxide, carbamate, amine, phosphinyl, nitro, acylhydrazide, hydrazide, imide, imine, amidate, amidine, oxime, peroxide, diazo, azide, ether, ester, lactam, lactone, urea, urethane, phosphonamide, sulfonamide, alcohol, aldehyde and ketone. In one embodiment, halogen may include fluorine, chlorine, bromine or iodine.

In one embodiment, k is from about 0 to about 5. In another embodiment, k is from about 1 to about 3.

In one embodiment, a, b, c, d, e and/or f are 0. In another embodiment, a, b, c, d, e and f are 0.

In one embodiment, R³, R⁴, R⁵, R⁶ and/or R⁷ may be methyl, ethyl, propyl, isopropyl, butyl, hexyl, heptyl, octyl, 4-methylpent-1-yl, phenyl, naphthyl or biphenyl.

In one embodiment, Y may be methyl, ethyl, propyl, isopropyl, butyl, hexyl, heptyl, octyl, 4-methylpent-1-yl, phenyl, naphthyl or biphenyl.

In one embodiment, the copolymer may comprise aromatic ether units from about 10 mole percent to about 90 mole percent. In another embodiment, the aromatic ether units are present from about 20 mole percent to about 80 mole percent. In another embodiment, the aromatic ether units are present from about 40 mole percent to about 60 mole percent. In one embodiment, the copolymer may comprise polyarylether units having amide functionality from about 10 mole percent to about 90 mole percent. In another embodiment, the polyarylether units having amide functionality are present from about 20 mole percent to about 80 mole percent. In another embodiment, the polyarylether units having amide functionality are present from about 40 mole percent to about 60 mole percent.

Polyarylether copolymers having amide functionality have a high glass transition temperature ranging from about 120° C. to about 280° C. in one embodiment, and ranging from about 140° C. to about 250° C. in another embodiment. In another embodiment, the T_{g} ranges from about 140° to about 225° C. and in another embodiment, the T_{g} ranges from about 175° C. to about 225° C.

The polyarylether copolymer having amide functionality has a molecular weight Mₙ in the range from about 10,000 g/mol to about 1,000,000 g/mol. In another embodiment, the Mₙ ranges from about 15,000 g/mol to about 200,000 g/mol. In another embodiment, the Mₙ ranges from about 20,000 g/mol to about 100,000 g/mol. In another embodiment, the Mₙ ranges from about 40,000 g/mol to about 80,000 g/mol.

In one embodiment, the M_{w} of the polymer may be in the range from about 10,000 g/mol to about 5,000,000 g/mol. In another embodiment, the M_{w} ranges from about 15,000 g/mol to about 1,000,000 g/mol. In another embodiment, the M_{w} ranges from about 20,000 g/mol to about 500,000 g/mol. In another embodiment, the Mₙ ranges from about 40,000 g/mol to about 400,000 g/mol.

The aromatic ether is any aromatic ether suitable for copolymerizing with the polyarylether having amide functionality. In one embodiment, the aromatic ether comprises units from formula IX or X:

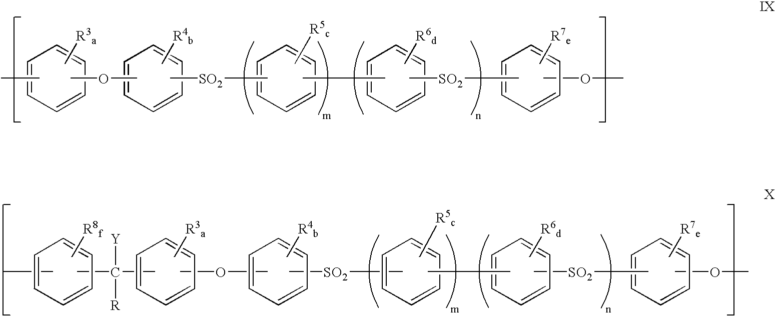

Wherein R³, R⁴, R⁵, R⁶, R⁷ and R⁸ are each, independently, a nitro group, C₁-C₁₂ alkyl, C₃-C₃₀ aryl or a combination thereof;

Y and R′ are each, independently, hydrogen, C₁-C₂₀ alkyl or C₃-C₃₀ aryl;

a, b, c, d, e and f are each, independently, 0, 1, 2, 3 or 4; and

m and n are each, independently, 0 or 1.

In one embodiment, a, b, c, d, e and/or f are 0. In another embodiment, a, b, c, d, e and f are 0.

In one embodiment, R³, R⁴, R⁵, R⁶ and/or R⁷ may be methyl, ethyl, propyl, isopropyl, butyl, hexyl, heptyl, octyl, 4-methylpent-1-yl, phenyl, naphthyl or biphenyl.

In one embodiment, Y may be methyl, ethyl, propyl, isopropyl, butyl, hexyl, heptyl, octyl, 4-methylpent-1-yl, phenyl, naphthyl or biphenyl.

In one embodiment, R′ may be methyl, ethyl, propyl, isopropyl, butyl, hexyl, heptyl, octyl, 4-methylpent-1-yl, phenyl, naphthyl or biphenyl.

The aromatic ether may be prepared by reacting a dihydroxyaromatic compound with a dihaloaromatic sulfone or a dinitroaromatic sulfone in the presence of a base and is prepared in situ with the reaction of the polyarylether having amide functionality.

In one embodiment, a polyarylether copolymer having amide functionality is prepared by reacting a dihydroxyaromatic compound, a dihydroxyaromatic compound having amide functionality and a dihaloaromatic sulfone or a dinitroaromatic sulfone in the presence of a base. Optionally, a solvent and a phase transfer catalyst may be used.

The dihydroxyaromatic compound includes, but is not limited to, bis(4-hydroxyphenyl)sulfide, bis(4-hydroxyphenyl)ether, bis(4-hydroxyphenyl)sulfone, bis(4-hydroxyphenyl)sulfoxide, 4,4′-(phenylphosphinyl)diphenol, 5-cyano-1,3-dihydroxybenzene, 4-cyano-1,3-dihydroxybenzene, 2-cyano-1,4-dihydroxybenzene, 2-methoxyhydroquinone, 2,2′-dimethylbiphenol, 2,2′,6,6′-tetramethylbiphenol, 2,2′,3,3′,6,6′-hexamethylbiphenol, 3,3′,5,5′-tetrabromo-2,2′,6,6′-tetramethylbiphenol, 2,2′-bis(4-hydroxyphenyl)hexafluoropropane, 4,4′-(3,3,5-trimethylcyclohexylidene)diphenol, 1,1-bis(4-hydroxy-3-methylphenyl)cyclohexane, 4,4′-bis(4-hydroxyphenyl)heptane, 2,4′-dihydroxydiphenylmethane, bis(2-hydroxyphenyl)methane, bis(4-hydroxyphenyl)methane, bis(4-hydroxy-5-nitrophenyl)methane, bis(4-hydroxy-2,6-dimethyl-3-methoxyphenyl)methane, 1,1-bis(4-hydroxyphenyl)ethane, 1,2-bis(4-hydroxyphenyl)ethane, 1,1-bis(4-hydroxy-2-chlorophenyl)ethane, 2,2-bis(3-phenyl-4-hydroxyphenyl)propane, 2,2-bis(4-hydroxy-3-methylphenyl)propane, 2,2-bis(4-hydroxy-3-ethylphenyl)propane, 2,2-bis(4-hydroxy-3-isopropylphenyl)propane, 2,2-bis(4-hydroxy-3,5-dimethylphenyl)propane, 3,5,3′,5′-tetrachloro-4,4′-dihydroxyphenyl)propane, bis(4-hydroxyphenyl)cyclohexylmethane, 2,2-bis(4-hydroxyphenyl)-1-phenylpropane, 2,4′-dihydroxyphenyl sulfone, 2,2-bis(4-hydroxyphenyl)butane, 2,2-bis(4-hydroxyphenyl)-2-methylbutane, 1,1-bis(4-hydroxyphenyl)cyclohexane, 2-(3-methyl-4-hydroxyphenyl-2-(4-hydroxyphenyl)propane, 2-(3,5-dimethyl-4-hydroxyphenyl)-2-(4-hydroxyphenyl)propane, 2-(3-methyl-4-hydroxyphenyl)-2-(3,5-dimethyl-4-hydroxyphenyl)propane, bis(3,5-dimethylphenyl-4-hydroxyphenyl)methane, 1,1-bis(3,5-dimethylphenyl-4-hydroxyphenyl)ethane, 2,2-bis(3,5-dimethylphenyl-4-hydroxyphenyl)propane, 2,4-bis(3,5-dimethylphenyl-4-hydroxyphenyl)-2-methylbutane, 3,3-bis(3,5-dimethylphenyl-4-hydroxyphenyl)pentane, 1,1-bis(3,5-dimethylphenyl-4-hydroxyphenyl)cyclopentane, 1,1-bis(3,5-dimethylphenyl-4-hydroxyphenyl)cyclohexane, bis(3,5-dimethyl-4-hydroxyphenyl)sulfoxide, bis(3,5-dimethyl-4-hydroxyphenyl)sulfone, bis(3,5-dimethylphenyl-4-hydroxyphenyl)sulfide, 2-carbamoylhydroquinone, 2,3-dicarbamoylhydroquinone, 2,2-bis(4-hydroxyphenyl)propane (bisphenol-A), resorcinol, catechol, hydroquinone, 2,6-dihydroxy naphthalene, 2,7-dihydroxynapthalene, 4,4′-dihydroxyphenyl sulfoxide, 2,4′-dihydroxyphenyl sulfoxide, 2-diphenylphosphinylhydroquinone, bis(2,6-dimethylphenol) 2,2′-biphenol, 4,4′-biphenol, 4,4′-bis(3,5-dimethyl)biphenol, 4,4′-bis(2,3,5-trimethyl)biphenol. 4,4′-bis(2,3,5,6-tetramethyl)biphenol, 4,4′-bis(3-bromo-2,6-dimethyl)biphenol, 4,4′-isopropylidenebis(2,6-dibromophenol) (tetrabromobisphenol A), 4,4′-isopropylidenebis(2,6-dimethylphenol) (tetramethylbisphenol A), 4,4′-isopropylidenebis(2-methylphenol), 4,4′-isopropylidenebis(2-allylphenol), 4,4′-isopropylidenebis(2-allyl-6-methylphenol), 4,4′-isopropylidene-bis(2-phenylphenol), 4,4′(1,3-phenylenediisopropylidene)bisphenol (bisphenol M), 4,4′-(1,4-phenylenediisoproylidene)bisphenol (bisphenol P), 4,4′-sufonylbis(2,6-dimethylphenol), 4,4′-hexafluoroisoproylidene)bisphenol (Bisphenol AF), 4,4′-hexafluoroisopropylidene)bis(2,6-dimethylphenol), 4,4′(1-phenylethylidene)bisphenol (Bisphenol AP), 4,4′-(1-phenylethylidene)bis(2,6-dimethylphenol), 3,3-(4-hydroxyphenyl)pentane, bis(4-hydroxyphenyl)-2,2-dichloroethylene (Bisphenol C), bis(2,6-dimethyl-4-hydroxyphenyl)methane, 4,4′-(cyclopentylidene)diphenol, 4,4′-(cyclohexylidene)bis(2-methylphenol), 4.4′-bis(4-hydroxyphenyl)diphenyl ether, 9,9-bis(3-methyl-4-hydroxyphenyl)fluorene, N-phenyl-3,3-bis-(4-hydroxyphenyl)phthalimide, 4,4′-(cyclododecylidene)diphenol, 4,4′-(bicyclo[2.2.1]heptylidene)diphenol, 4,4′-(9H-fluorene-9,9-diyl)diphenol, 3,3-bis(4-hydroxyphenyl)isobenzofuran-1(3H)-one, 1-(4-hydroxyphenyl)-3,3-dimethyl-2,3-dihydro-1H-inden-5-ol, 1-(4-hydroxy-3,5-dimethylphenyl)-1,3,3,4,6-pentamethyl-2,3-dihydro-1H-inden-5-ol, 3,3,3′,3′-tetramethyl-2,2′,3,3′-tetrahydro-1,1′-spirobi[indene]-5,6′-diol (Spirobiindane), dihydroxybenzophenone (bisphenol K), tris(4-hydroxyphenyl)methane, tris(4-hydroxyphenyl)ethane, tris(4-hydroxyphenyl)propane, tris(4-hydroxyphenyl)butane, tris(3-methyl-4-hydroxyphenyl)methane, tris(3,5-dimethyl-4-hydroxyphenyl)methane, tetrakis(4-hydroxyphenyl)ethane, tetrakis(3,5-dimethyl-4-hydroxyphenyl)ethane, bis(4-hydroxyphenyl)phenylphosphine oxide, dicyclopentadienylbis(2,6-dimethyl phenol), dicyclopentadienyl bis(2-methylphenol) or dicyclopentadienyl bisphenol.

The dihydroxyaromatic compound having amide functionality, the dihaloaromatic sulfone or dinitroaromatic sulfone and the base are described above.

The dihaloaromatic or dinitroaromatic sulfone may be used in substantially equimolar amounts relative to the combined amount of dihydroxyaromatic compound and dihydroxyaromatic compound having amide functionality. The term “substantially equimolar amounts” means a molar ratio of the dihaloaromatic sulfone or dinitroaromatic sulfone to the combined amount of dihydroxyaromatic compound and dihydroxyaromatic compound having amide functionality is from about 0.85 to about 1.2 of the dihaloaromatic sulfone or dinitroaromatic sulfone per mole of the combined amount of dihydroxyaromatic compound and dihydroxyaromatic compound having amide functionality. In another embodiment, the ratio is from about 0.9 to about 1.1 of the dihaloaromatic sulfone or dinitroaromatic sulfone per mole of the combined amount of dihydroxyaromatic compound and dihydroxyaromatic compound having amide functionality. In another embodiment, the ratio is from about 0.98 to about 1.02 of the dihaloaromatic sulfone or dinitroaromatic sulfone per mole of the combined amount of dihydroxyaromatic compound and dihydroxyaromatic compound having amide functionality.

The amount of base is the amount needed to deprotonate the hydroxyl groups of the dihydroxyaromatic compound and the dihydroxyaromatic compound having amide functionality. In one embodiment, the base is present in at least an equimolar amount relative to the molar equivalents of hydroxyl functionality. In another embodiment, the base is present in an excess amount relative to the molar equivalents of hydroxyl functionality. In one embodiment, the reaction is conducted at a temperature ranging from about 100° C. to about 300° C. In another embodiment, the temperature is in a range from about 120° C. to about 200° C. In another embodiment, the reaction temperature is in a range from about 150° C. to about 200° C.

The reaction is conducted for a time sufficient to react the dihydroxyaromatic compound, the dihydroxyaromatic compound having amide functionality and the dihaloaromatic sulfone or dinitroaromatic sulfone. In one embodiment, the reaction is conducted for a time period ranging from about 1 hour to about 72 hours. In another embodiment, the time period ranges from about 1 hour to about 10 hours. The reaction may be carried out under ordinary pressure or pressurized conditions.

The reaction mixture may be dried by adding an additional solvent to the initial reaction mixture. The additional solvent forms an azeotrope with water. Examples of such solvents include, but are not limited to, toluene, benzene, xylene, ethylbenzene or chlorobenzene. After removal of any residual water by azeotropic drying, the reaction is carried out at the reaction temperatures described above.

After completing the reaction, the polyarylether copolymer having amide functionality may be separated from the inorganic salts in the reaction mixture by precipitation into a non-solvent and collected by filtration and drying. The drying may be carried out either under vacuum and/or at high temperature, as is known commonly in the art.

The solvent is as defined above and the amount of solvent to be used is typically an amount that is sufficient to dissolve the reactants.

The phase transfer catalyst is as defined above and the phase transfer catalyst may be used in any amount effective for increasing the rate of reaction or increasing the yield of the reaction. In one embodiment, the phase transfer catalyst is added in an amount of from about 0.5 mole percent to about 5.0 mole percent based on the molar amount of the combined dihydroxyaromatic compound and dihydroxyaromatic compound having amide functionality. In another embodiment, the phase transfer catalyst is added in an amount of from about 0.25 mole percent to about 2.5 mole percent based on the molar amount of the combined dihydroxyaromatic compound and dihydroxyaromatic compound having amide functionality.

In one embodiment, the polyarylether having amide functionality is blended with at least one resin. The selection of the resin imparts different properties to the blend, such as improved heat resistance, biocompatibility, and the like. In one embodiment, a blend comprises a polyarylether having amide functionality and one or more resins, the polyarylether having amide functionality comprises units from at least one of structure I or structure II:

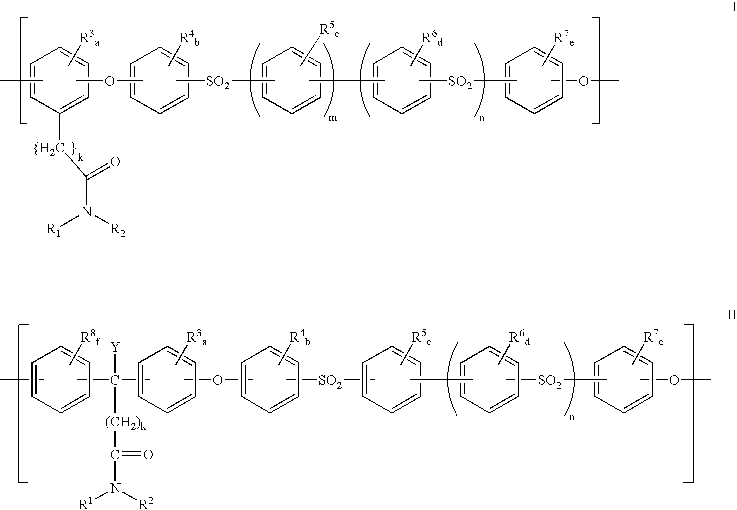

wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl;

R³, R⁴, R⁵, R⁶, R⁷ and R⁸ are each, independently, a nitro group, C₁-C₁₂ alkyl, C₃-C₃₀ aryl or a combination thereof;

Y is hydrogen, C₁-C₂₀ alkyl or C₃-C₃₀ aryl;

k is from about 0 to about 10;

a, b, c, d, e and f are each, independently, 0, 1, 2, 3 or 4; and

m and n are each, independently, 0 or 1.

In one embodiment, R₁ and/or R₂ may be methyl, ethyl, propyl, isopropyl, butyl, hexyl, heptyl, octyl, 4-methylpent-1-yl, phenyl, furanyl, thienyl, naphthyl or biphenyl. In another embodiment, R₁ and R₂ are covalently connected to form a cyclic moiety. In one embodiment, R₁ and R₂ form a cycloalkyl group. In another embodiment, R₁ and R₂ form a cyclohexyl group.

In another embodiment, R₁ and/or R₂ may be a substituted C₃-C₃₀ aryl group. In one embodiment, R₁ and/or R₂ are a C₃-C₃₀ aryl, such as phenyl, naphthyl or biphenyl, substituted with one or more members selected from the group consisting of C₁-C₂₀ alkyl, C₃-C₃₀ aryl, halogen, nitrile, amide, hydroxyl, aryloxy, alkoxy, thioalkoxy, thioaryloxy, carbonyl, sulfonyl, carboxylate, carboxylic ester, sulfone, phosphonate, sulfoxide, carbamate, amine, phosphinyl, nitro, acylhydrazide, hydrazide, imide, imine, amidate, amidine, oxime, peroxide, diazo, azide, ether, ester, lactam, lactone, urea, urethane, phosphonamide, sulfonamide, alcohol, aldehyde and ketone. In one embodiment, halogen may include fluorine, chlorine, bromine or iodine.

In one embodiment, k is from about 0 to about 5. In another embodiment, k is from about 1 to about 3.

In one embodiment, Y may be methyl, ethyl, propyl, isopropyl, butyl, hexyl, heptyl, octyl, 4-methylpent-1-yl, phenyl, naphthyl or biphenyl.

In one embodiment, a, b, c, d, e and/or f are 0. In another embodiment, a, b, c, d, e and f are 0.

In one embodiment, R³, R⁴, R⁵, R⁶ and/or R⁷ may be methyl, ethyl, propyl, isopropyl, butyl, hexyl, heptyl, octyl, 4-methylpent-1-yl, phenyl, naphthyl or biphenyl.

In one embodiment, the polyarylether having amide functionality in the blend is a homopolymer as described above. In another embodiment, the polyarylether having amide functionality is a copolymer as described above.

The resin may be hydrophilic or hydrophobic in nature. Examples of resins that may be blended with the polyarylether having amide functionality include polysulfone, polyether sulfone, polyether urethane, polyphenylene sulfone, polyamide, polyether-amide, polyacrylonitrile, polyvinylpyrrolidone (PVP), polyoxazoline, polyethyleneglycol, polypropylene glycol, polyglycolmonoester, copolymers of polyethyleneglycol with polypropylene glycol, water-soluble cellulose derivatives, polysorbate, polyethylene-polypropylene oxide copolymers or polyethyleneimines.

In one embodiment, the blend comprises from about 20 to about 99 percent by weight polyarylether having amide functionality and from about 1 to about 80 percent by weight of a resin, based on the weight of the blend. In another embodiment, the blend comprises from about 50 to about 98 percent by weight polyarylether having amide functionality and from about 2 to about 50 percent by weight of the resin, based on the weight of the blend. In another embodiment, the blend comprises from about 75 to about 95 percent by weight polyarylether having amide functionality and from about 5 to about 25 percent by weight of the resin, based on the weight of the blend.

In one embodiment, the resin is PVP. PVP is a polymer that easily dissolves in water and can be easily eluted with water or blood from a membrane, such as a hollow fiber membrane. PVP can be insolubilized by cross-linking. When PVP is completely insolubilized, it will not elute from a membrane, but will also diminish hydrophilic properties in the membrane. In one embodiment, a portion of PVP is insolubilized by cross-linking. In another embodiment, from about 5 to about 50 percent by weight of the PVP is crosslinked. In this range, the elution of the PVP is inhibited, while the blend maintains hydrophilic properties.

PVP may be crosslinked by known methods. U.S. Pat. No. 6,432,309 and U.S. Pat. No. 5,543,465, incorporated herein by reference, disclose methods for crosslinking PVP. Some exemplary methods of crosslinking include, but are not limited to, exposing PVP to heat, radiation, such as X-rays, alpha rays, beta rays, gamma rays, ultraviolet rays, visible radiation, infrared radiation, electron beams, or by chemical methods such as, but not limited to, treating PVP with a crosslinker, such as potassium peroxodisulfate or ammonium peroxopersulfate, at temperatures ranging from about 20° C. to about 80° C. in an aqueous medium at pH ranges from about 4 to about 9, and for a time period ranging from about 5 minutes to about 60 minutes.

PVP may be obtained by polymerizing an N-vinylpyrrolidone using standard addition polymerization techniques known in the art. One polymerization procedure involves free radical polymerization using initiators, such as azobisisobutyronitrile (AIBN), optionally, in the presence of a solvent. PVP is also commercially available under the tradenames PLASDONE® from ISP COMPANY or KOLLIDON® from BASF.

In another embodiment, a method for making a blend comprises mixing a polyarylether having amide functionality and one or more resins, wherein said polyarylether having amide functionality comprises units from at least one of structure I or structure II:

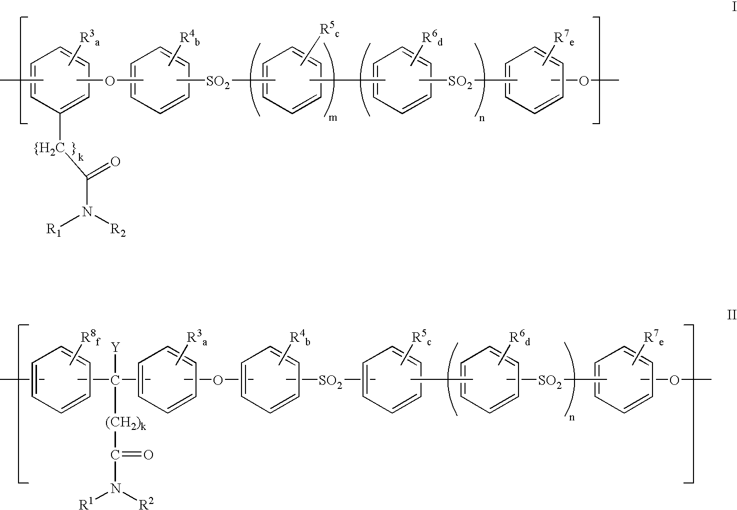

wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl;

R³, R⁴, R⁵, R⁶, R⁷ and R⁸ are each, independently, a nitro group, C₁-C₁₂ alkyl, C₃-C₃₀ aryl or a combination thereof;

Y is hydrogen, C₁-C₂₀ alkyl or C₃-C₃₀ aryl;

k is from about 0 to about 10;

a, b, c, d, e and f are each, independently, 0, 1, 2,3 or 4; and

m and n are each, independently, 0 or 1.

In one embodiment, R₁ and/or R₂ may be methyl, ethyl, propyl, isopropyl, butyl, hexyl, heptyl, octyl, 4-methylpent-1-yl, phenyl, furanyl, thienyl, naphthyl or biphenyl. In another embodiment, R₁ and R₂ are covalently connected to form a cyclic moiety. In one embodiment, R₁ and R₂ form a cycloalkyl group. In another embodiment, R₁ and R₂ form a cyclohexyl group.

In another embodiment, R₁ and/or R₂ may be a substituted C₃-C₃₀ aryl group. In one embodiment, R₁ and/or R₂ are a C₃-C₃₀ aryl, such as phenyl, naphthyl or biphenyl, substituted with one or more members selected from the group consisting of C₁-C₂₀ alkyl, C₃-C₃₀ aryl, halogen, nitrile, amide, hydroxyl, aryloxy, alkoxy, thioalkoxy, thioaryloxy, carbonyl, sulfonyl, carboxylate, carboxylic ester, sulfone, phosphonate, sulfoxide, carbamate, amine, phosphinyl, nitro, acylhydrazide, hydrazide, imide, imine, amidate, amidine, oxime, peroxide, diazo, azide, ether, ester, lactam, lactone, urea, urethane, phosphonamide, sulfonamide, alcohol, aldehyde and ketone. In one embodiment, halogen may include fluorine, chlorine, bromine or iodine.

In one embodiment, k is from about 0 to about 5. In another embodiment, k is from about 1 to about 3.

In one embodiment, Y may be methyl, ethyl, propyl, isopropyl, butyl, hexyl, heptyl, octyl, 4-methylpent-1-yl, phenyl, naphthyl or biphenyl.

In one embodiment, a, b, c, d, e and/or f are 0. In another embodiment, a, b, c, d, e and f are 0.

In one embodiment, R³, R⁴, R⁵, R⁶ and/or R⁷ may be methyl, ethyl, propyl, isopropyl, butyl, hexyl, heptyl, octyl, 4-methylpent-1-yl, phenyl, naphthyl or biphenyl.

In order that those skilled in the art will be better able to practice the present disclosure, the following examples are given by way of illustration and not by way of limitation.

### EXAMPLES

### Example 1

Synthesis of Polysulfone-Amides:

Diphenolic Morpholinamide (2.843 g, 8.0 mmol) was added to a three-neck flask installed with a Dean-Stark Condenser, a dropping funnel, and a mechanical stir. K₂CO₃ (1.66 g, 12 mmol), N,N-dimethylacetamide (DMAc) (10 ml), and 8 ml toluene was added to the flask. The solution was heated to 155° C. to remove water and toluene by azeotropic distillation. After 2.5 hours, bis(4-fluorophenyl)sulfone (2.034 g, 8.0 mmol) was added. After 3 hours, the solution became very viscous. During cooling, 25 ml of DMAc was added to the mixture. The solution was precipitated in water and washed with water and methanol. The polymer was dried to afford 4.4 g polysulfone-amide (Mw=84,280, PDI=4.8, Tg=186° C.).

### Example 2

Diphenolic Morpholinamide (4.7496 g, 13.36 mmol), 4,4′-bis[(4-chlorophenyl)sulfonyl]-1,1′-biphenyl (6.7643 g, 13.44 mmol), K₂CO₃ (2.7721 g, 20.06 mmol), sulfolane (29.6 g), and toluene (60 ml) were added to a three-neck flask installed with a Dean-Stark Condenser, a dropping funnel, and a mechanical stirrer. The mixture was heated to 160 to 180° C. to remove water and toluene by azeotropic distillation. After 6 hours, the solution was very viscous and the reaction was stopped. During cooling, 75 g of DMAc were added to the flask. The mixture was filtered and the resulting clear solution was precipitated in water. The resulting polymer was filtered, washed with water and dried. The resulting polymer was redissolved in chloroform (120 g) and precipitated in methanol to give 9.0 grams of a fluffy white powder of the polyarylether having amide functionality (Mw=93,000, PDI=3.1, Tg=223° C.).

### Example 3

### Synthesis of a Polyether Random Co-Polymer Having Amide Functionality:

Diphenolic Morpholinamide (2.488 g, 7.0 mmol) and Bisphenol A (1.598 g, 7 mmol) were added to a three-neck flask installed with a Dean-Stark Condenser, a dropping funnel, and a mechanical stir. K₂CO₃ (2.764 g, 20 mmol), NMP (20 ml), and toluene (8 ml) were added to the flask. The solution was heated to 180° C. to remove water and toluene by azeotropic distillation. After 2.5 hours, bis(4-chlorophenyl)sulfone (4.020 g, 14.0 mmol) was added. After 6 hours, the solution became very viscous. During cooling, 20 ml of NMP was added to the mixture. The solution was precipitated in water, and washed with water and methanol. The polymer was dried to afford 7.0 g of polyarylether copolymer having amide functionality (Mw=63,000 PDI=3.5, Tg=176° C.).

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

1. A method for making a polyarylether having amide functionality comprising reacting a dihydroxyaromatic compound having amide functionality with a dihaloaromatic sulfone or a dinitroaromatic sulfone in the presence of a base.

2. The method of claim 1 further comprising adding a solvent.

3. The method of claim 2 further comprising adding a phase transfer catalyst.

4. The method of claim 1, wherein the dihydroxyaromatic compounds having amide functionality comprises structure IV or V: 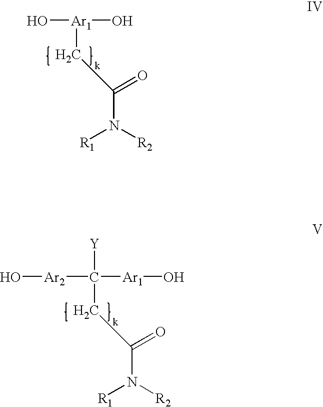
wherein R₁ and R₂ are separate groups or are covalently bonded to form a cyclic moiety, R₁ and R₂ are each, independently, selected from the group consisting of hydrogen, C₁-C₂₀ alkyl, C₃-C₃₀ aryl and a substituted C₃-C₃₀ aryl;
k is from about 0 to about 10;
Y is hydrogen, C₁-C₂₀ alkyl or C₃-C₃₀ aryl; and
Ar₁ and Ar₂ are each, independently, a C₃-C₃₀ aryl group, a C₃-C₃₀ aromatic-aliphatic group or a substituted C₃-C₃₀ substituted aryl group.

5. The method of claim 1 wherein the dihaloaromatic sulfone or dinitroaromatic sulfone comprises formula VI: 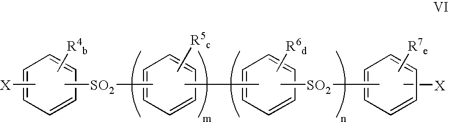
wherein X is a halogen or nitro group;
R⁴, R⁵, R⁶ and R⁷ are each, independently, a nitro group, C₁-C₁₂ alkyl, C₃-C₃₀ aryl or a combination thereof;
m and n are each, independently, 0 or 1; and
b, c, d and e are each, independently, 0, 1, 2,3 or 4.

6. The method of claim 5 wherein the dihaloaromatic sulfone is selected from the group consisting of bis(4-chlorophenyl)sulfone, bis(4-fluorophenyl)sulfone, 4′-bis[(4-chlorophenyl)sulfonyl]-1,1′-biphenyl and 4,4′-bis[(4-fluorophenyl)sulfonyl]-1,1′-biphenyl.

7. The method of claim 1 wherein the base is a basic salt of an alkali metal compound.

8. The method of claim 7 wherein the base is selected from the group consisting of alkali metal hydroxide, alkali metal carbonate, alkali metal hydrogen carbonates and combinations thereof.

9. The method of claim 3 wherein the phase transfer catalysts are selected from the group consisting of guanidinium salts, aminopyridinium salts, bis-quaternary ammonium salts, bis-quaternary phosphonium salts and phosphazenium salts.

10. The method of claim 1 wherein the temperature of the reaction is from about 100° C. to about 300° C.

11. The method of claim 1 wherein the time of the reaction is from about 1 hour to about 72 hours.

12. The method of claim 1 wherein the dihaloaromatic sulfone or dinitroaromatic sulfone and the dihydroxy aromatic compound with amide functionality are in substantially equimolar amounts.

13. The method of claim 1 further comprising adding a dihydroxyaromatic compound.

14. The method of claim 13 wherein the dihaloaromatic sulfone or dinitroaromatic sulfone are in substantially equimolar amounts with the combined total of dihydroxyaromatic compound and the dihydroxyaromatic compound having amide functionality.

15. A polyarylether having amide functionality comprises units from at least one of structure I or structure II: 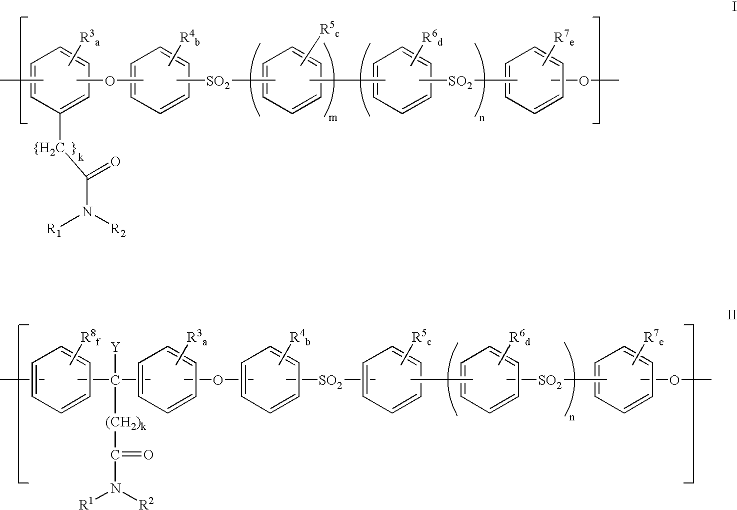
wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl;
R³, R⁴, R⁵, R⁶, R⁷ and R⁸ are each, independently, a nitro group, C₁-C₁₂ alkyl, C₃-C₃₀ aryl or a combination thereof;
k is from about 0 to about 10;
Y is hydrogen, C₁-C₂₀ alkyl or C₃-C₃₀ aryl;
a, b, c, d, e and f are each, independently, 0, 1, 2, 3 or 4; and
m and n are each, independently, 0 or 1.

16. The polyarylether of claim 15 wherein the polyarylether having amide functionality has the units of structure VII: 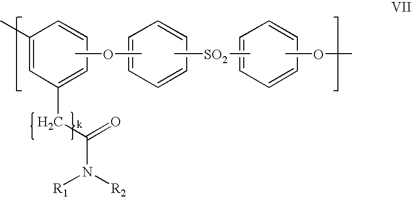
wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl; and
k is from about 0 to about 10.

17. The polyarylether of claim 15 having a glass transition temperature from about 120° C. to about 280° C.

18. The polyarylether of claim 15 wherein the polyarylether having amide functionality is a homopolymer.

19. The polyarylether of claim 15 wherein the polyarylether having amide functionality is a copolymer.

20. The polyarylether of claim 19 wherein the polyarylether further comprises units from an aromatic ether.

21. The polyarylether of claim 20, wherein the aromatic ether comprises units from formula IX or X: 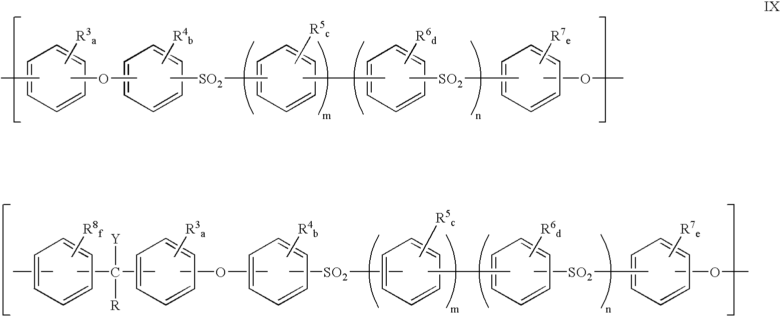
wherein R³, R⁴, R⁵, R⁶, R⁷ and R⁸ are each, independently, a nitro group, C₁-C₁₂ alkyl, C₃-C₃₀ aryl or a combination thereof;
Y and R′ are each, independently, hydrogen, C₁-C₂₀ alkyl or C₃-C₃₀ aryl;
a, b, c, d, e and f are each, independently, 0, 1, 2, 3 or 4; and
m and n are each, independently, 0 or 1.

22. A blend comprising a polyarylether having amide functionality and one or more resins, the polyarylether having amide functionality comprises units from at least one of structure I or structure II: 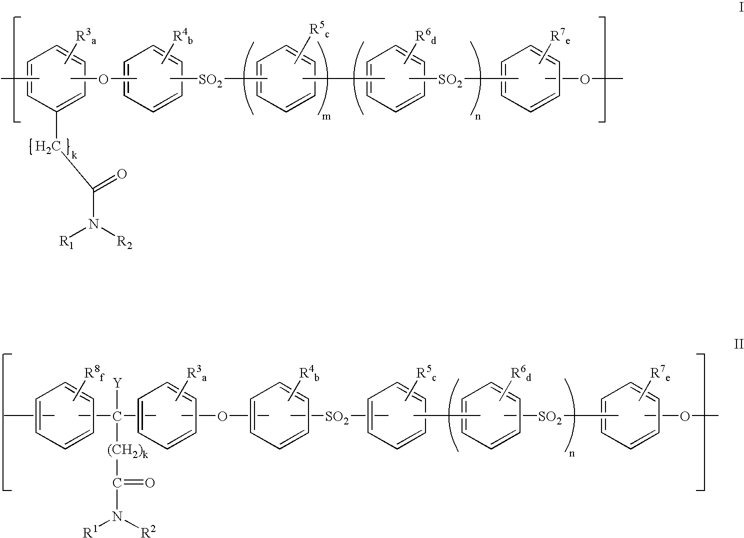
wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl;
R³, R⁴, R⁵, R⁶, R⁷ and R⁸ are each, independently, a nitro group, C₁-C₁₂ alkyl, C₃-C₃₀ aryl or a combination thereof;
Y is hydrogen, C₁-C₂₀ alkyl or C₃-C₃₀ aryl;
k is from about 0 to about 10;
a, b, c, d, e and f are each, independently, 0, 1, 2, 3 or 4; and
m and n are each, independently, 0 or 1.

23. The blend of claim 22 wherein the polyarylether having amide functionality has the units of structure VII: 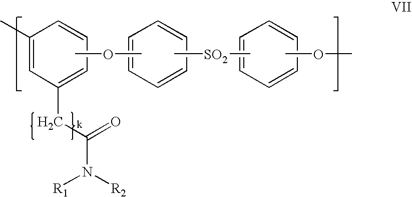
wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl; and
k is from about 0 to about 10.

24. The blend of claim 22 wherein the polyarylether having amide functionality is a homopolymer.

25. The blend of claim 22 wherein the polyarylether having amide functionality is a copolymer.

26. A method for making a blend comprises mixing a polyarylether having amide functionality and one or more resins, wherein said polyarylether having amide functionality comprises units from at least one of structure I or structure II: 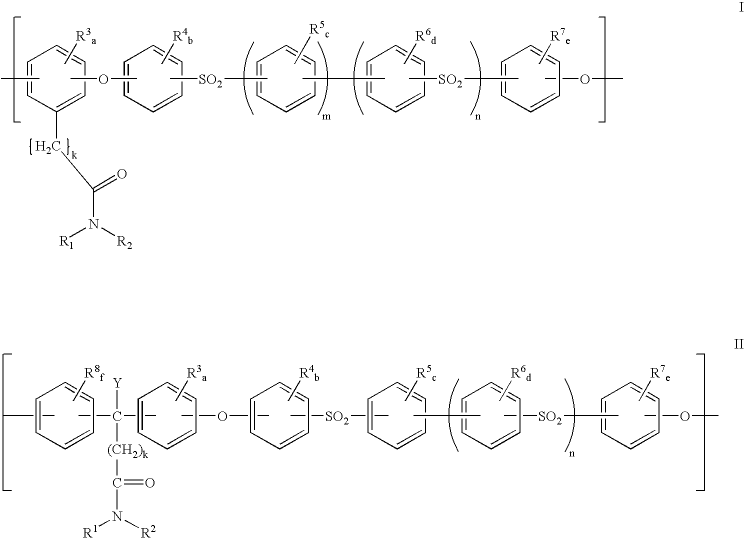
wherein R₁ and R₂ are separate groups or are covalently connected to form a cyclic moiety, R₁ and R₂ are each, independently, selected from the group consisting of hydrogen, C₁-C₂₀ alkyl, C₃-C₃₀ aryl and a substituted C₃-C₃₀ aryl;
R³, R⁴, R⁵, R⁶, R⁷ and R⁸ are each, independently, a nitro group, C₁-C₁₂ alkyl, C₃-C₃₀ aryl or a combination thereof;
Y is hydrogen, C₁-C₂₀ alkyl or C₃-C₃₀ aryl;
k is from about 0 to about 10;
a, b, c, d, e and f are each, independently, 0, 1, 2, 3 or 4; and
m and n are each, independently, 0 or 1.
